(19) United States
(12) Patent Application Publication
(10) Pub. No.: US 2014/0089019 A1
(43) Pub. Date: Mar. 27, 2014

(54) System and Method for Vacation Club Management

(71) Applicant: Wade Allan Petrowich, Palm Desert, CA (US)

(72) Inventor: Wade Allan Petrowich, Palm Desert, CA (US)

(21) Appl. No.: 14/032,967

(22) Filed: Sep. 20, 2013

Related U.S. Application Data
(60) Provisional application No. 61/705,354, filed on Sep. 25, 2012.

(51) Int. Cl. G06Q 10/02

(52) U.S. Cl. CPC G06Q 10/02
USPC 705/5

(57) ABSTRACT

A system and method for vacation club management. Embodiments can include recording a vacation club ownership interest in a database, receiving details pertaining to the vacation club ownership interest, receiving a first point amount pertaining to the vacation club ownership interest, recording a travel activity, receiving a second point amount of points used for the travel activity, and calculating a remaining point amount based on the first point amount and the second point amount.

### CROSS-REFERENCE TO RELATED APPLICATIONS

This application claims priority to U.S. Provisional Application 61/705,354, filed Sep. 25, 2012 and entitled VACATION CLUB MANAGEMENT SYSTEM, METHOD AND APPARATUS, the entire contents of which are hereby incorporated by reference.

### BACKGROUND

The vacation club industry includes a large marketplace of resorts around the world that sell time-based ownership rights to resort units. An owner of a timeshare unit has the right to use the unit for a certain amount of days or weeks per year. While the timeshare deed or right-to-use agreement is usually tied to a specific unit and a specific date range of the year, some timeshare resorts and clubs allow a timeshare owner to visit other locations at different times. This is typically accomplished by assigning a point value to a length of time spent at a particular unit in a particular season. An owner can then exchange some or all of the point value of their purchased unit and time to obtain a stay at a different resort.

Frequently, these timeshare points can also be exchanged or converted for use with affiliate programs. Such affiliate programs can include frequent flyer miles, hotel points, other timeshare clubs and exchanges, and so forth. However, the timeshare owner has to convert the timeshare points to affiliate points and keep track of the used points, remaining points, and so forth. The process becomes increasingly complicated for individuals owning multiple timeshares, which may be at various clubs or resorts, each of which may have their own point system and affiliate groups. Recording and managing such data can be frustrating, and timeshare owners resort either to manually entering the data in a ledger or spreadsheet, or simply calling customer support for an explanation of available points and options.

A solution for easily managing timeshare ownership and affiliate data is therefore desired.

### SUMMARY

According to at least one exemplary embodiment, a system for vacation club management is disclosed. The system can include a database for storing data related to at least one user account stored in the database, the data including at least one vacation club ownership interest associated with the user account, vacation club details associated with the ownership interest, a point amount associated with the ownership interest, and at least one travel activity associated with the ownership interest. The system can further include a communications link for connecting to at least one remote computing device, and at least one processor programmed with instructions such that the system is operable to record a vacation club ownership interest in the database, receive details pertaining to the vacation club ownership interest, receive a first point amount pertaining to the vacation club ownership interest, record a travel activity, receive a second point amount used for the travel activity, and calculate a remaining point amount based on the first point amount and the second point amount.

According to another exemplary embodiment, a method for vacation club management is disclosed. The method can include recording a vacation club ownership interest in a database, receiving details pertaining to the vacation club ownership interest, receiving a first point amount pertaining to the vacation club ownership interest, recording a travel activity, receiving a second point amount of points used for the travel activity, and calculating a remaining point amount based on the first point amount and the second point amount.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1 is a schematic of an exemplary embodiment of a networked computer system.

FIG. 2 shows an exemplary embodiment of a vacation club management system.

FIG. 3a shows an exemplary menu interface for a vacation club management system.

FIG. 3b shows an exemplary vacation club portfolio interface for a vacation club management system.

FIG. 3c shows an exemplary vacation club details interface for a vacation club management system.

FIG. 3d shows an exemplary travel activity partner interface for a vacation club management system.

FIG. 4 shows an exemplary method of registering an ownership interest in a vacation club with a vacation club management system.

FIG. 5 shows exemplary point usage interfaces of a vacation club management system.

FIG. 6 shows an exemplary method of tracking a user's travel activity.

FIG. 7 shows an exemplary vacation club snapshot interface for a vacation club management system.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

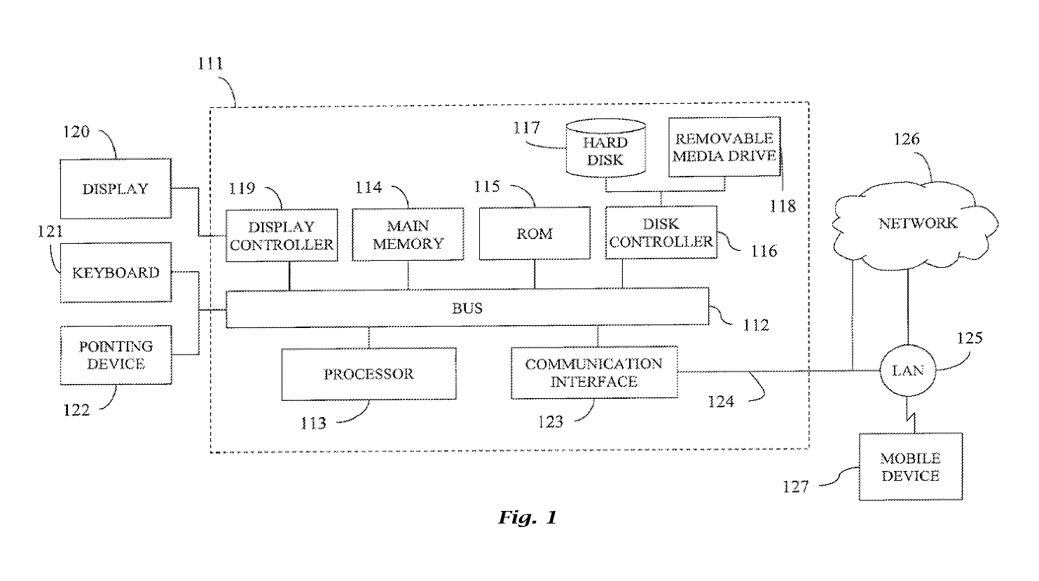

FIG. 1 illustrates an exemplary computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to bus 112 to control a display 120, such as a cathode ray tube (CRT), liquid crystal display (LCD) or any other type of display, for displaying information to a computer client. The computer system includes input devices, such as a keyboard 121 and a pointing device 122, for interacting with a computer client and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be a wireless link. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., an 802.11-compliant wireless network) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission.

According to at least one exemplary embodiment, a system and method for vacation club management are disclosed. The system can allow timeshare club members to track timeshare ownership information and to easily convert vacation club points into affiliate program points. The system can allow a member to track: each vacation club of which the user is a member; the type, size, and other characteristics of each ownership interest (e.g., specific units, length of timeshare ownership, ownership periods, and so forth) in the club owned by the user; the contract number and any other related data for each ownership interest; for each interest, the type of timeshare usage owned by the member; the point value of each timeshare usage; any timeshare exchange networks of which the user is a member or with which each vacation club is associated; and any affiliate programs of which the user is a member or with which each vacation club is associated. For each timeshare ownership interest, the system can further track the points that have been used by the owner; the points that are remaining; and the points that have been converted for use with an affiliate program or timeshare exchange network. Additional features of the system disclosed herein can include providing easy access to contact information for each vacation club, including the owner services phone number with auto dial, the owner services website address with direct link, and any other pertinent information. The system can also provide easy access with direct links to websites for affiliate point programs such as hotel point programs, timeshare exchange partner networks, and loyalty point programs such as airline miles. The system can further offer the owner local information services, including local maps, live navigation, and information about local businesses, destinations, transit terminals and points of interest, for example airports, ports, bus and rail stations, restaurants, banks, bars, theaters, recreational sites, and so forth. The system can further include social network aspects. For example, the system can allow the owner to maintain a personal profile, which can include a photo gallery, news feed, blog, and so forth, and to connect and follow the personal profiles of other owners registered with the system. The system can further provide a directory of links to popular travel sites, timeshare sites, or any other desired sites. The system may be implemented on a variety of computing devices, including personal computers, portable devices, tablets, smartphones, and so forth, and a variety of operating systems. Interfaces for the system may be implemented via the web, or on customized applications for a particular operating system.

In exemplary embodiments of the vacation club management system, a user, who may be an owner of an interest in one or more vacation clubs, can register an account with the system. The owner can subsequently input data relating to their interest in any vacation clubs, as well data relating to their accounts with affiliates and exchanges, as described in detail below.

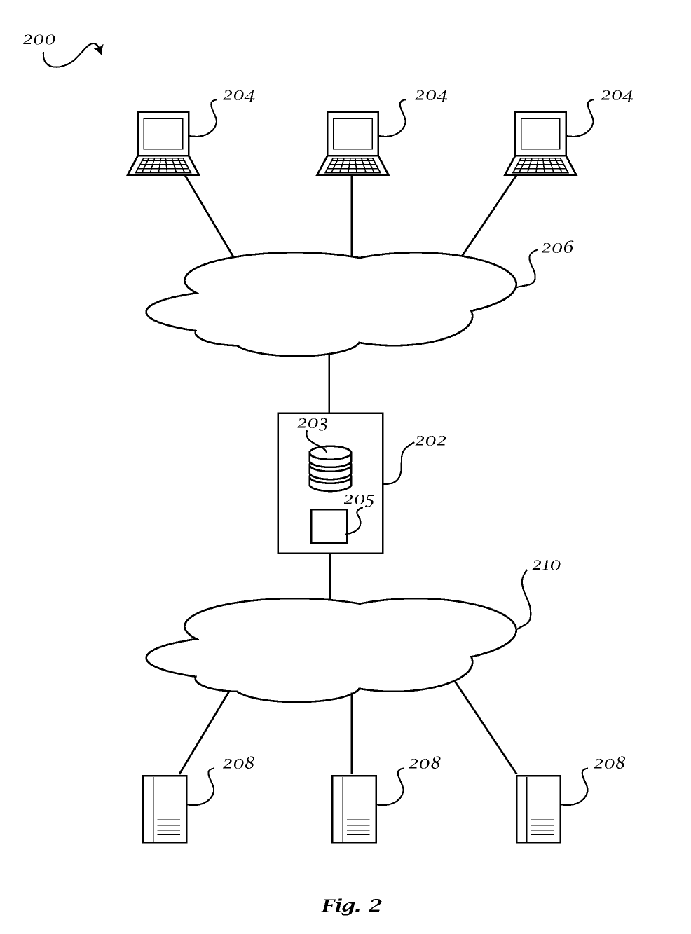

FIG. 2 shows an exemplary embodiment of a vacation club management system 200. Vacation club management system 200 can include a server 202 having a database 203 on which a variety of data may be stored and a processor 205 for executing software instructions. Server 202 may be communicatively coupled, for example through a network 206, to any number of computers 204, computing devices or communication devices, such as, but not limited to, smart phones and tablet computers, as well as any other type of computing or communication device. Additionally, server 202 may be communicatively coupled, for example over a network 210 to a plurality of third party servers 208, for example servers of vacation club systems, hotel systems, and travel activity provider systems.

Server 202 may function in a manner so as to provide and store any of a variety of data. For example, when accessed via network 206, server 202 may provide website content and website access. In such an example, a user at computer 204 may be able to navigate to the website housed on server 202. The user at computer 204 may then be able to view data or gain access to an area of the website that is customized for that user, for example pages providing user-desired content and user-provided information.

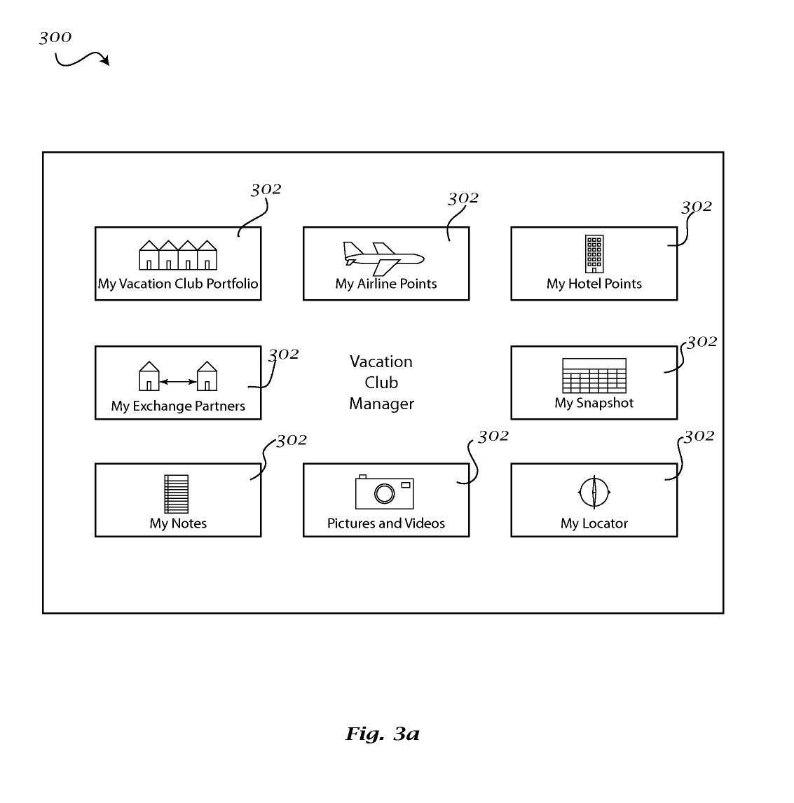

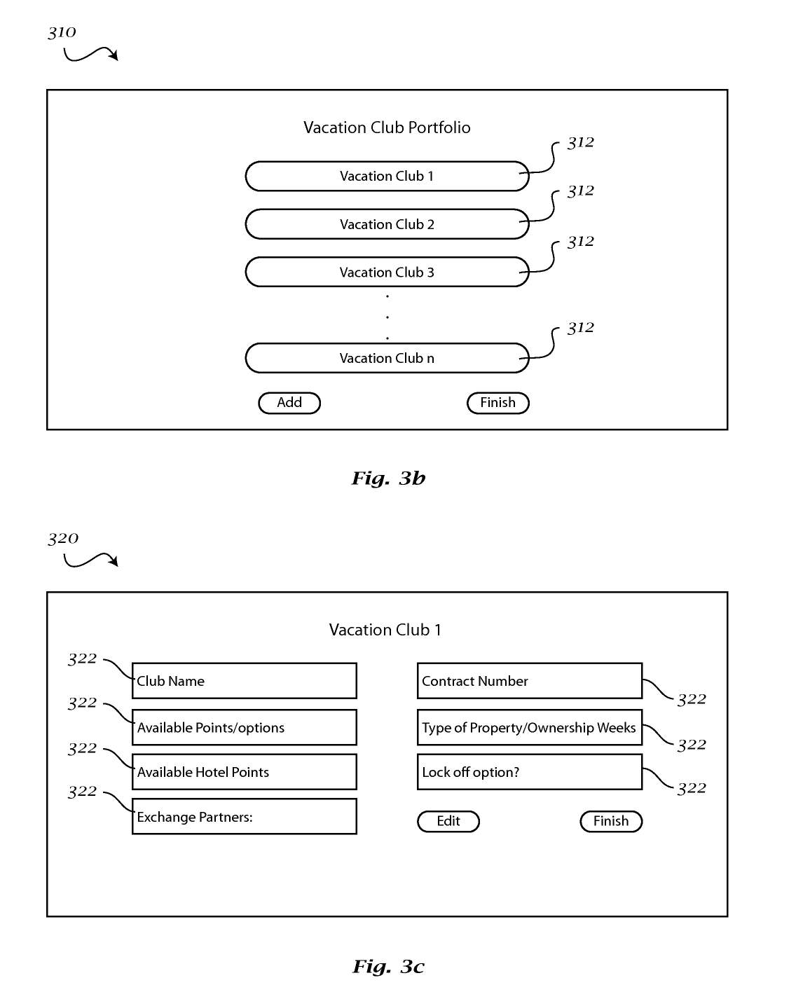

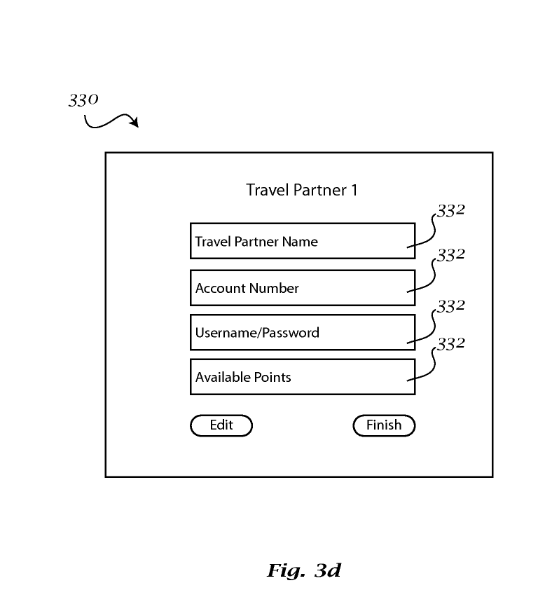

FIG. 3a shows an exemplary menu interface 300 for a vacation club management system. The menu interface can include links 302 for viewing a user's vacation club portfolio, viewing the user's affiliate points such as airline and hotel points, viewing the owner's timeshare exchange networks, viewing the user's personal profile, including photos and videos, viewing and editing notes, viewing a vacation snapshot, and viewing local information, such as business, destination, transit terminal, and point of interest information. The user can click each of the links to display the corresponding interface for that link. These interfaces are discussed in detail below.

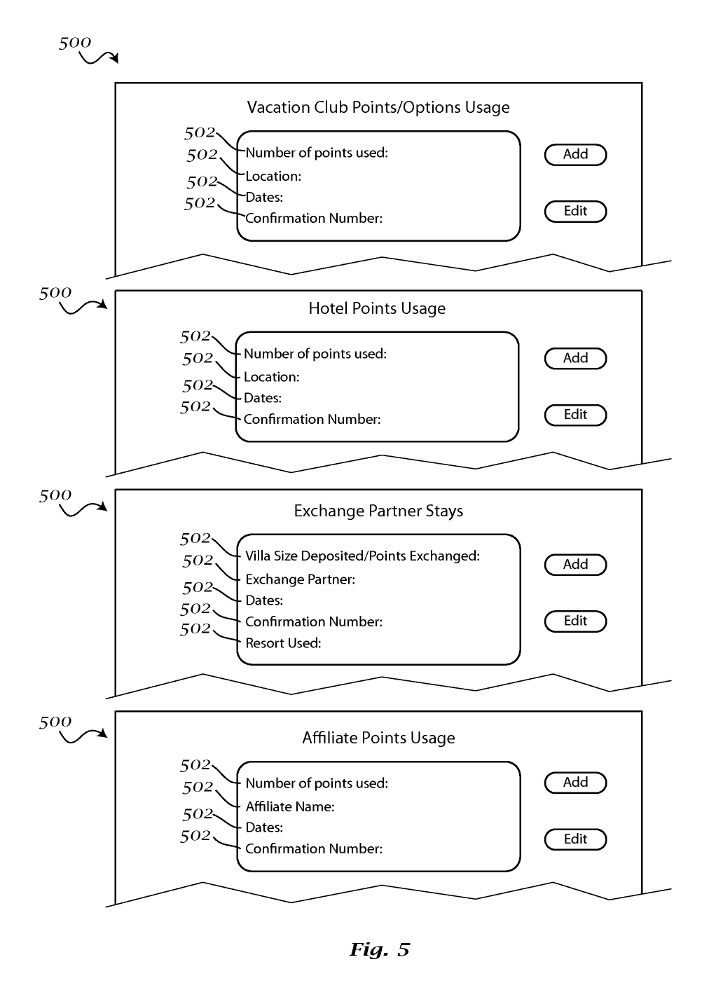

System 200 can allow the user to register any desired amount of vacation club ownership interests, including a plurality of interests at the same vacation club, as well as a plurality of diverse vacation clubs of which the user is a member, or in which the user has one or more interests. The system can then display each vacation club interest to the user, for example in the vacation club portfolio interface 310 shown in FIG. 3b. This can provide the user with easy access to information pertaining to each vacation club interest. For example, the exemplary vacation club portfolio interface 310 can include a listing of each vacation club of which the user is a member. Each vacation club in the list can be provided as a clickable widget 312 that the user can select to view a vacation club details interface 320, shown in FIG. 3c. Additionally, the vacation club portfolio interface can allow the user to modify the portfolio so as to add or remove vacation clubs. Adding a vacation club can likewise bring up details interface 320 or a similar interface to allow the user to input details regarding the newly added club. The details interface 320 can allow the user to view or edit specific details 322 regarding a particular vacation club. Selecting any of the points details can bring up a related point tracking interface 500, shown in FIG. 5.

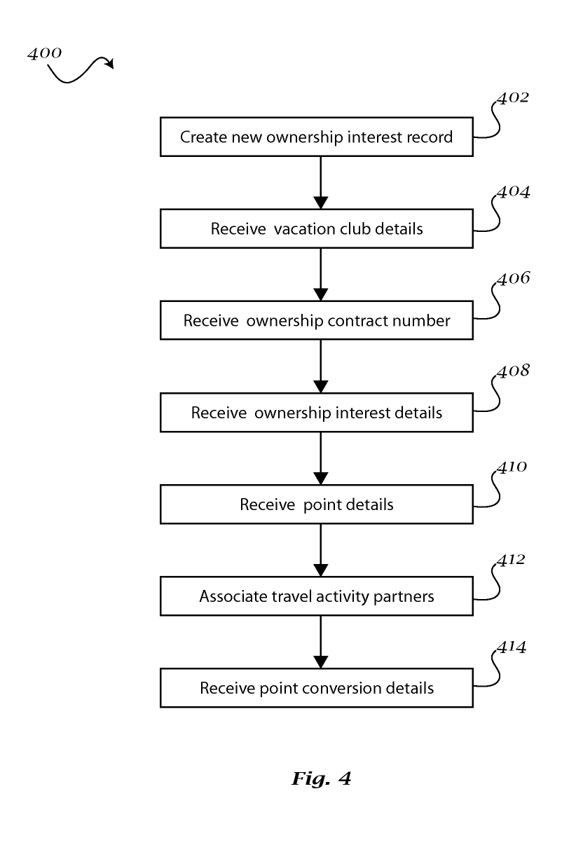

FIG. 4 shows an exemplary embodiment of a method 400 for registering an interest in a vacation club. At step 402, a new vacation club interest record is created in the database 208 of system 200. At step 404, system 200 can receive details regarding the vacation club from the user. Exemplary club details may include the name of the vacation club, the location of the vacation club, the exchange partners affiliated with the vacation club, and so forth. At step 406, system 200 can receive the user's contract number with the vacation club, which can be input by the user. At step 408, system 200 can receive details of the user's interest in the vacation club. Exemplary ownership interest details can include the property type, the property size, the property location, the time range of ownership, the existence of a lock-off option, and so forth. At step 410, the system can receive club point details for the user's interest in the vacation club. Exemplary club point details can include the amount of club points and options, the amount of affiliate points such as hotel points, and so forth. Furthermore, the point details can include the user's total annual points for the vacation club interest, as well as the user's remaining points for the vacation club interest for the year. In some exemplary embodiments, information for steps 408 and 410 may be input manually by the user. In other exemplary embodiments, system 200 may communicate with the system of the vacation club and automatically retrieve data for steps 408 and 410 from the vacation club system based on the user's contract number and any other necessary identifying information.

The information input into system 200 in method 400, including the club details, interest details and club point details may then be displayed to the user by system 200 in the vacation club details interface 320 of FIG. 3c. In particular, the system can display the total amount of club points and/or options that the user receives for a particular year, the remaining amount of points and/or options, and any points that are available for use with affiliates such as hotels, exchange partners, and loyalty programs. Furthermore, some or all of the ownership details may only be shown if the particular resort does not utilize a point/option based system. System 200 can further allow the user to edit any of the above data at any desired time.

System 200 can also allow the user to register any desired amount of travel activity partners of which the user is a member. The term “travel activity partner,” as used herein, can include vacation club exchange partners, hotel point affiliates, loyalty point programs, and so forth. Vacation club exchange partners, also known as vacation exchange networks, can be associations of vacation clubs that allow owners of vacation club interests to exchange a portion of their time ownership interest for a stay at another vacation club. Hotel point affiliates can be hotel companies or chains that allow owners of vacation club interests to exchange a portion of their time ownership interest for a stay at a participating hotel. Loyalty point programs can include certain hotel point programs, airline miles, charge card reward programs, and so forth. The loyalty point programs can allow owners of vacation club interests to exchange a portion of their time ownership interest for points in the loyalty point programs, for example a certain amount of miles on a participating airline.

In some exemplary embodiments, at step 412, travel activity partners such as exchange partners, hotel point affiliates, and loyalty point programs can be associated with at least one ownership interest in a vacation club. The user may associate the travel activity partners by selecting the desired field when registering an ownership interest in the vacation club, thereby informing system 200 that the particular travel activity partners is associated with the particular ownership interest.

Once the user selects the desired field, system 200 can then bring up a corresponding travel activity partner interface 330, shown in FIG. 3d. The travel activity partner interface 330 can allow the user to view and edit travel activity partner details 332. For example, for vacation club exchange partners, the system can display to the user a list of exchange partners so as to provide the user with easy access to information pertaining to each exchange partner. To register an exchange partner, the user can provide system 200 with exchange partner details, such as the name of the exchange partner, the user's account number with the exchange partner; and login credentials such as the username and password of the user's account with the exchange partner. Additional details may be contemplated and provided as desired. System 200 may communicate with the system of the exchange partner, automatically retrieve any additional desired data relating to the user's account, and display the data to the user. Similarly, for hotel point affiliates or loyalty point programs, system 200 can display to the user a list of such point programs so as to provide the user with easy access to information pertaining to each point program. To register a loyalty/hotel point program, the user can provide system 200 with details of the loyalty point program, such as the name of the loyalty/hotel point program, the user's account number with the loyalty/hotel point program; and the username and password of the user's account with the loyalty point program. Additional details may be contemplated and provided as desired. System 200 may communicate with the system of the loyalty point program, automatically retrieve any additional desired data relating to the user's account, and display the data to the user.

Once the travel partners are associated, system 200 can receive point conversion details at step 414. The point conversion details may be obtained automatically from the remote systems of the vacation club, exchange partner, or loyalty program. The point conversion details may alternatively be entered manually by the user, for example as multiplication factors for converting vacation club points to travel activity partner points. The point conversion details can include a plurality of such factors, for example seasonal or class factors, so as to provide for different point conversion ratios based on date, season, class of vacation club interest, class of exchange property requested, travel class, and so forth.

Once the travel activity partners are registered with system 200, the system can display to the user the converted point values of the user's vacation club interest points. Thus, for example, the system can display to the user the amount of vacation club points that the user has at the time, the equivalent hotel points, the equivalent airline miles, the equivalent exchange partner points, and so forth.

System 200 can further provide for tracking of the user's travel activity. Such travel activity can include stays at vacation clubs, stays at hotels, use of exchange partners, and usage of loyalty programs, and so forth. The system can track the date of such activity, the locations of the activity, the points used for the activity, and any other desired information relating to the activity.

Additionally, at any time that a user's point balance changes, system 200 may track and record such changes. The user's point balance may change, for example, when the user stays at a vacation club, stays at a hotel, utilizes an exchange partner of the vacation club, utilizes an frequent travel reward system, or otherwise converts their points.

FIG. 5 shows exemplary point usage interfaces 500. The point usage interfaces 500 may be provided for the user's vacation club ownership interest, as well as for travel activity providers such as exchange partners, hotel point affiliates, loyalty programs, and so forth. The point usage interfaces can each include at least one field 502, or a plurality of fields, with each field pertaining to a particular instance of a travel activity. The fields can further display a list of details regarding the travel activity, for example, the number of points used for the activity, the location of the activity, the dates of the activity, and any confirmation numbers used for the activity. The point usage interfaces can further allow the user to add a new travel activity for tracking of the activity by system 200 or to edit an already recorded travel activity.

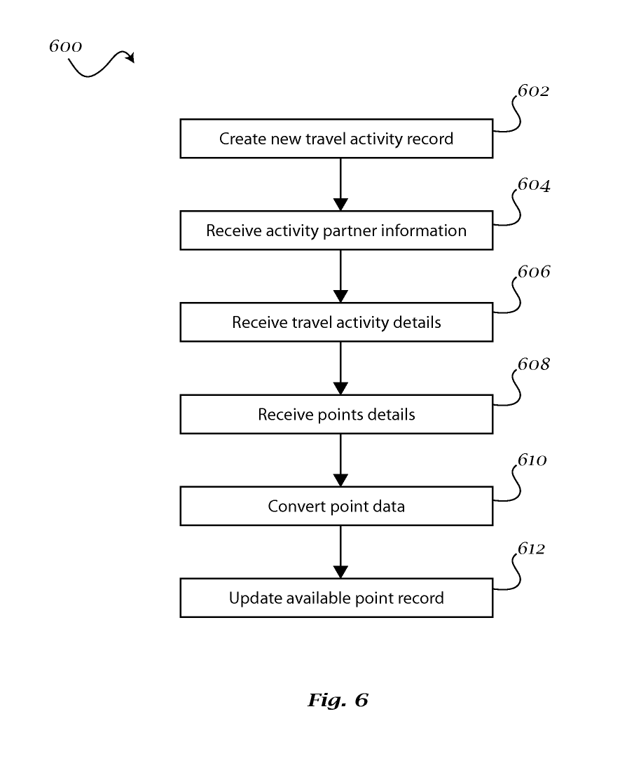

FIG. 6 shows an exemplary embodiment of a method 600 for tracking a user's travel activity. At step 602, a new travel activity record can be created in the database 208 of system 200. At step 604, system 200 may receive information as to the travel activity partner that the user utilized for the travel activity. System 200 may also receive information as to the type of travel activity. Travel activity types can include, for example, a stay at a vacation club, a stay at a hotel or other affiliate, a stay at exchange partner location, a flight or other loyalty program usage, and so forth. The travel activity provider type may be provided to system 200 by the user. For example, the user can select, via an interface of system 200, to record a new travel activity and then select the provider of the travel activity (i.e. vacation club, hotel, exchange partner, loyalty program, etc.) that has already been registered with system 200. At step 606, system 200 can receive details regarding the travel activity. The travel details may include the location of the travel activity, the dates of the travel activity, any confirmation or identification numbers of the travel activity, and so forth. At step 608, system 200 can receive data as to the points used, if any, for the travel activity. In some exemplary embodiments, data for steps 604 through 608 may be input manually by the user. In other exemplary embodiments, a part or all of steps 604 through 608 may be performed by system 200. For example, system 200 may communicate with the remote systems of the travel activity partners and retrieve data for steps 604 through 608 from the vacation club system based on the user's contract number and any other necessary identifying information. The system can receive this data, for example, upon user request or by monitoring the systems of the travel providers and retrieving any activity updates, for example changes to point balances or other activity logs.

Upon receiving data as to points used for the travel activity, system 200 can, if necessary, convert the point data, at step 610. For example, if a user has utilized their vacation club points to purchase airline miles, the system can convert the used airline miles to vacation club points. At step 612, the system can then update the recorded point data, for example by subtracting the used points from the total points available to the user. The updated point records can then be displayed to the user, providing a user with easy access to up-to-date point values.

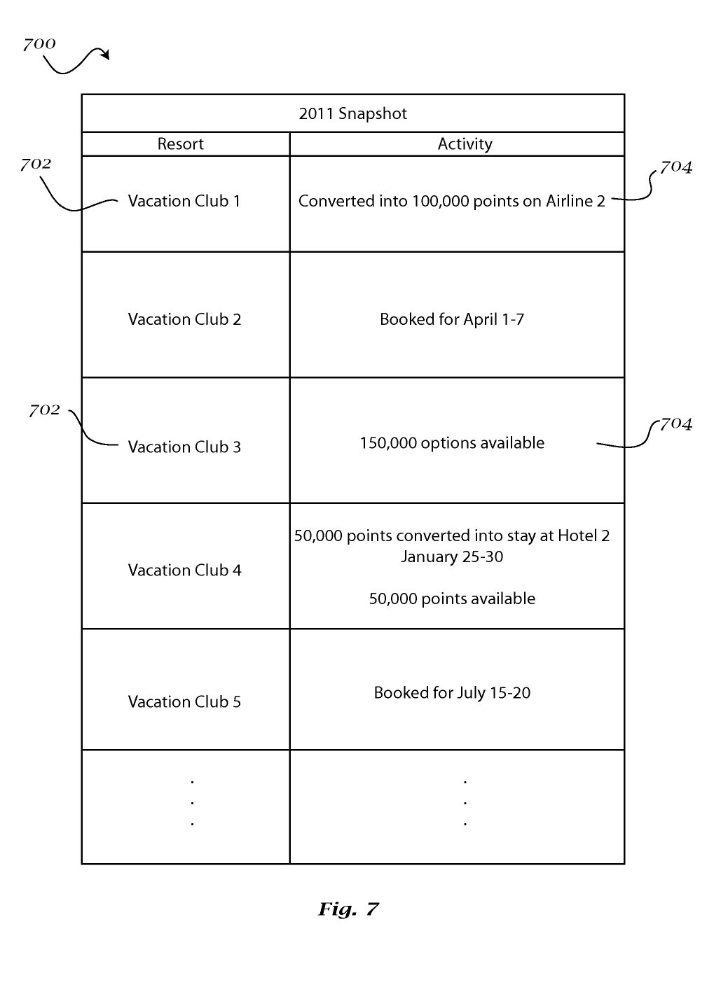

System 200 can provide the user with a log or snapshot of the user's vacation club information and travel activities. An exemplary snapshot interface 700 is shown in FIG. 7. The snapshot interface can show all or part of a user's activity for a particular time range. For example, the snapshot interface can show the user's club stays, hotel stays, exchanges, flights, and any other desired information, for a particular year, in a chronological format. The snapshot interface can show the name 702 of the club, resort, or other company with which an action was performed, and the particular type of action 704 performed. Such actions can include point conversions, dates and time ranges of stay bookings, available points, and so forth. The user can select any particular item in the vacation club interface to display detailed information about the particular item.

In one exemplary embodiment, the snapshot interface may be organized by the user's vacation club ownership interests. System 200 can display each vacation club ownership interest of the user. For each ownership interest, system 200 can further display the activities that the user has undertaken with that interest. For example, if a user has booked a stay in the property corresponding to that interest, the dates and other details of the booking may be displayed. If a user has exchanged part or all of that interest, for example with an exchange partner, hotel point affiliate, loyalty point program, or other travel activity partner, the details of the exchange, such as the amount of points exchanged, may be displayed. Clicking on any particular ownership interest can show further details of the activities undertaken for that ownership interest, such as dates, locations, point usage, and so forth.

System 200 can further include capabilities for recording user notes for travel activities. The user can use the notes interface to keep notes about any particular vacation, stay, flight, exchange, or any other travel activity. The system can automatically record the date and time of entry of a note and organize the notes in any desired manner, for example by associating the note with an instance of a travel activity recorded by system 200. The presence of note may be indicated to the user, for example, in the vacation snapshot interface.

System 200 can further include capabilities for finding and viewing local information. System 200 can allow the user to locate any desired points of interest, such as hotels, airports, and vacation clubs, as well as landmarks, recreational facilities, and so forth. The user may enter the name of the point of interest and the city in which the point of interest is located. Subsequently, the system may present the user with at least one search result, showing the name, address and contact information for the point of interest. The contact information may include phone numbers, websites, email addresses, and so forth. The user may then select a particular piece of contact information to launch an email editor, web browser, voice communications program, and so forth so as to easily connect to the point of interest. System 200 can also allow the user to view a map containing the point of interest and to obtain directions to the point of interest from the user's location or any other desired location. The map and direction software may be any software known in the art, or may be proprietary to the vacation club management system.

System 200 can further include social networking aspects, such as personal profile pages. The personal profile interfaces can allow the user to create a personal page, as well as albums having multimedia content such as photographs and videos of the user's vacation experiences, or any other desired photos and videos. The photo and video content may be grouped into albums by the user, or may be grouped automatically by the system based on the metadata of the multimedia content, such as metadata indicating, for example, date, time, location, of the content, or any other metadata. The personal profile interface may be visible to other users of the system, and the user may have control over viewing permissions for the personal profile page. For example the user can limit the viewing permissions to select users or to all users. Additionally, a “follow me” widget may be provided on the personal profile interface, allowing other users to easily see the user's content, for example in a news feed or similar arrangement. The “follow me” interface can further include an arrangement of photographs, videos, and/or albums, which may be arranged according to any desired criteria and in any desired layout, for example, rows, columns, arrays, or a simulative layout such as a corkboard, album, video player, or any other layout that may be contemplated.

The various interfaces of system 200 can also include shortcut links to the other interfaces of the vacation club management system, as well as links to bookmarked websites. The links may be grouped into link bars, for example an internal link bar for links to the interfaces of the system and an external link bar for links to bookmarked websites. The website bookmarks may be selected and edited by the user. A default set of website bookmarks may also be provided by the system, for example, popular travel websites and the like. The link bars may be displayed in any appropriate location on the interface, for example at the edges of the interface. The display of the link bars may further be toggled by the user. It should be understood that the link bars may be displayed, if desired, in any of the interfaces of the system described herein.

Additionally, for each vacation club or travel partner registered with system 200, easy links to the vacation club or travel partner may be provided to the user by system 200. For example, in any interface where the vacation club or travel partner is displayed, system 200 can provide links to the website of the vacation club or travel partner, the contact information of the vacation club or travel partner, and so forth. For example, the user may click on the vacation club or travel partner name to be taken to the website thereof.

Thus, the embodiments disclosed herein can allow vacation club owners to manage the facets of their vacation club benefits, including managing points, booking club and hotel stays, exchanging points, and booking affiliate programs. The system can track a plurality of clubs, exchanges, affiliates and hotels, a plurality of properties within each club, and a plurality of accounts. The system can be operable to convert point values between clubs, hotels, exchanges, affiliates, and so forth. The conversion may be performed automatically using conversion values sourced from the clubs, exchanges, affiliates and hotels, or may be entered manually by the users. The system can also present all such data in a convenient manner and in a single online location. Furthermore, the system can provide easy access to common travel and vacation sites. The system can also include social networking functionality, including the posting of photographs, videos, blogs, and news feeds to a user's profile page, and the ability the user to allow other users, friends, family, or any other desired individual, to follow and view the user's personal profile page.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A computer-implemented method for vacation club management, comprising:
recording a vacation club ownership interest in a database;
receiving details pertaining to the vacation club ownership interest;
receiving a first point amount pertaining to the vacation club ownership interest;
recording a travel activity;
receiving a second point amount of points used for the travel activity; and
calculating a remaining point amount based on the first point amount and the second point amount.

2. The method of claim 1, further comprising:
associating a travel activity partner to the ownership interest; and
receiving point conversion details between the vacation club ownership interest and the travel activity partner.

3. The method of claim 2, wherein calculating a remaining point amount further comprises:
converting the second point amount to a third point amount based on the point conversion details; and
calculating a remaining point amount based on the first point amount and the third point amount.

4. The method of claim 2, wherein the travel activity partner is a vacation club exchange partner, a hotel point affiliate, or a loyalty point program.

5. The method of claim 2, further comprising receiving details pertaining to the travel activity partner, wherein the details pertaining to the travel activity partner include one or more of: travel activity partner name, an account number associated with the travel activity partner, and login credentials associated with the travel activity partner.

6. The method of claim 1, wherein details pertaining to the vacation club ownership interest include one or more of: vacation club name, vacation club location, a contract number associated with the ownership interest, property type, property size, property location, time range of fractional ownership, lock-off option existence, and vacation club contact information.

7. The method of claim 1, further comprising displaying, to a user, the details pertaining to the vacation club ownership interest and the remaining point amount.

8. The method of claim 1, further comprising receiving details pertaining to the travel activity, wherein the details pertaining to the travel activity include one or more of: a location of the travel activity, dates of the travel activity, and identification numbers of the travel activity.

9. The method of claim 8, further comprising displaying, to a user, the travel activity, the details of the travel activity, and the second point amount.

10. The method of claim 1, further comprising displaying, to a user, a snapshot of the user's vacation club ownership interests and associated travel activities for a desired time range.

11. A vacation club management system, comprising:
a database for storing data related to at least one user account stored in the database, the data including at least one vacation club ownership interest associated with the user account, vacation club details associated with the ownership interest, a point amount associated with the ownership interest, and at least one travel activity associated with the ownership interest;
a communications link for connecting to at least one remote computing device; and
at least one processor programmed with instructions such that the system is operable to record a vacation club ownership interest in the database, receive details pertaining to the vacation club ownership interest, receive a first point amount pertaining to the vacation club ownership interest, record a travel activity, receive a second point amount used for the travel activity, and
calculate a remaining point amount based on the first point amount and the second point amount.

12. The system of claim 11, wherein the at least one remote computing device is a computing device of a user having a user account stored in the database.

13. The system of claim 11, wherein the at least one remote computing device is a computing device of a travel activity partner.

14. The system of claim 11, wherein the system is further operable to associate a travel activity partner to the ownership interest, and receive point conversion details between the vacation club ownership interest and the travel activity partner.

15. The system of claim 15, wherein the system is further operable to convert the second point amount to a third point amount based on the point conversion details, and calculate a remaining point amount based on the first point amount and the third point amount.

16. The system of claim 11, wherein the system is further operable to present an interface to a user displaying the details pertaining to the vacation club ownership interest and the remaining point amount.

17. The system of claim 11, wherein the system is further operable to receive details pertaining to the travel activity, wherein the details pertaining to the travel activity include one or more of: a location of the travel activity, dates of the travel activity, and identification numbers of the travel activity.

18. The system of claim 17, wherein the system is further operable to present an interface to a user displaying the travel activity, the details of the travel activity, and the second point amount.

19. The system of claim 11, wherein the system is further operable to present an interface to a user displaying a snapshot of the user's vacation club ownership interests and associated travel activities for a desired time range.

20. The system of claim 11, wherein the system is further operable to:
receive multimedia content from a user associated with a travel activity; and
present an interface to a user displaying the multimedia content.
